(19) United States
(12) Patent Application Publication
(10) Pub. No.: US 2012/0050435 A1
(43) Pub. Date: Mar. 1, 2012

(54) RECORDING APPARATUS

(75) Inventors: Toshiro Sugiyama, Yokohama-shi (JP); Yukimichi Kimura, Kawasaki-shi (JP)

(73) Assignee: CANON KABUSHIKI KAISHA, Tokyo (JP)

(21) Appl. No.: 13/219,424

(22) Filed: Aug. 26, 2011

(30) Foreign Application Priority Data
Aug. 31, 2010 (JP) 2010-193570

(51) Int. Cl. B41J 2/01

(52) U.S. Cl. 347/102; 347/104

(57) ABSTRACT

A recording apparatus according to the invention includes a weight roller arranged between a platen and a winding device and configured to come into contact with a surface of a recording material to exert a conveyance resistance thereon against the direction of conveyance of the recording material, and a conveyance resistance switching mechanism configured to switch the state between a state of exerting a predetermined conveyance resistance by the weight roller and a state of reducing the predetermined conveyance resistance or a state of releasing the exertion of the predetermined conveyance resistance. The conveyance resistance exerted by the weight roller is larger than the difference between a conveying force by the winding device and a predetermined conveying force for causing the recording material to be conveyed, and is smaller than a sum of a conveying force of the conveying roller and the conveying force of the winding device.

### BACKGROUND OF THE INVENTION

1. Field of the Invention

The present invention relates to a conveying device configured to discharge and convey a rolled recording material from an image forming unit and a recording apparatus having the conveying device. More specifically, the invention relates to an inkjet recording apparatus configured to heat and dry ink.

2. Description of the Related Art

In recent years, coated paper, non-coated paper, cloth, a vinyl chloride-based material, polyester-based material and so on are used as a recording material in inkjet recording apparatus in the field of sign and display, so that recording on wide variety of materials is enabled. Also, these materials are used for various indoor and outdoor applications such as outdoor advertising displays, indoor graphics, vehicle wrappings. High degree of precision, high quality and high-speed recording of images as well as waterproofing and weather resistant properties are required for the inkjet recording apparatus of this type. In order to realize these requirements, a configuration of promoting fixation of ink by heating the recording material or drying ink dropped on the recording material using a heating unit such as a heater is used in many cases.

In the related art, a method of heating the recording materials by a printing heater for accelerating drying of ink and controlling the degree of heating by the printing heater depending on the recording material is described in Japanese Patent No. 3329882. According to the description in Japanese Patent No. 3329882, since adequate heat is applied according to the recording material and drying of ink is accelerated almost without affecting other portions, distortion of the recording material or blurring of ink is reduced, and high-quality printing is enabled even at a high-speed printing.

Also, in WO04/094150, a configuration having a recording head configured to eject ink for recording, a pre-heater configured to pre-heat a rolled recording material before recording, an after heater configured to dry the recording material after recording is described. The configuration described in WO04/094150 includes a winding device configured to wind the recording material after recording. In this configuration, since the surface of the recording material is pre-heated by the pre-heater, ink droplets ejected from nozzles of the recording head and dropped on the recording material can be heated and dried in an early stage on the surface portion of the recording material. In this configuration, the ink droplets are prevented from permeating widely over the recording material in the periphery of dropped positions by the after heater, so that clear recording of graphics or characters without blurring is enabled.

However, there is a case where wrinkles may be generated on the recording material due to the effect of heating by the heater, so that there may arise a problem in that smooth conveyance of the recording material is hindered due to the influence of the wrinkles and hence recording quality is impaired. As a countermeasure, a configuration in which a tension mechanism is provided on the downstream side in the direction of conveyance of the recording material with respect to an area of a recording operation in which the recording on the recording material is performed by the recording head is described in Japanese Patent No 4059899. In this configuration, a tensile force is exerted on the recording material by the tension mechanism arranged between the pre-heater and the after heater configured to heat the recording material having subjected to recording by the recording head, so that generation of wrinkles on a recording material 101 is restrained.

However, in the configuration in which the winding device is provided as described above, there arise a case where smooth conveyance cannot be achieved due to the characteristics of the recording material and a case of generating wrinkles on the recording material itself due to the tensile force or the heating. Subsequently, causes of generation of wrinkles will be described.

First of all, an influence of the tensile force exerted on the recording material will be described. When the tensile force is exerted on the recording material in the direction of conveyance, the recording material is expanded in the direction of conveyance, while is contracted in the direction of the width orthogonal to the direction of conveyance. As a result of this contraction, wrinkles are generated in the direction orthogonal to the direction of the width, which is a direction of contraction, that is, in the direction of conveyance of the recording material.

Since the recording material is in a state of being nipped (constrained) between a conveying roller and a pinch roller while being conveyed, contraction in the direction of the width does not occur on the conveying roller. However, the amount of contraction in the direction of the width tends to increase as it goes downstream in the direction of conveyance. In other words, since the amount of contraction increases as it goes downstream in the direction of conveyance, the provability of generation of wrinkles increases. In contrast, in the vicinity of the conveying roller, the amount of contraction is small, and hence the probability of generation of wrinkles is low.

In this manner, expansion and contraction of the recording material become a cause of generation of wrinkles. In other words, a recording material which can hardly be expanded or shrunk, that is, which has greater rigidity, demonstrates a propensity not to be subjected to generation of wrinkles.

Subsequently, influence exerted by heating will be described. The great majority of recording materials are softened by being heated, that is, reduced in rigidity. Therefore, when the recording material is heated, expansion and contraction are liable to occur. In addition, since the recoding material is expanded in volume, expansion occurs in the direction of conveyance and in the direction of the width. With this action, the recording material becomes susceptible to generation of wrinkles when heated. However, the wrinkles are little generated by being simply heated, and significant expansion and contraction occur by being exerted with the tensile force in the heated state and, consequently, wrinkles are generated.

In addition, as a factor of further accelerating the above-described two causes, there are various non-uniformities.

The non-uniformities include, for example, non-uniformities regarding the recording material such as the thickness, the fiber density and the surface state of the recording material, or non-uniformities of the magnitude of the tensile force or the action of the tensile force. Due to these non-uniformities, the amount of contraction and the amount of expansion vary depending on the positions in the longitudinal direction of the recording material, thereby accelerating the generation of wrinkles.

In this manner, the recording material is subject to generation of wrinkles due to expansion and contraction. Therefore, the recording material demonstrates such propensity that the higher the rigidity of the recording material, the lower the probability of generation of wrinkles becomes.

The inkjet recording apparatus performs recording on various types of recording materials. For example, as the recording material for outdoor advertising displays, a tarpaulin (water-proof cloth) formed by laminating a high-molecular resin film on a filament (long fiber) layer or a vinyl chloride-based film is used. Among these recording materials, the tarpaulin, having relatively high rigidity, is not subject to generation of wrinkles. However, the tarpaulin has a property to increase adhesiveness when heated to high temperatures and hence tends to be adhered to a platen, so that smooth conveyance on the platen may be hindered. Therefore, it is necessary to wind the recording material while exerting a tensile force equal to or larger than a force of adhesion of the tarpaulin as the recording material to the platen by its adhesive strength by, for example, a winding device.

In contrast, the recording material having a relatively low rigidity such as the vinyl chloride-based film is further softened when heated and is subject to generation of wrinkles. There is a problem of generation of more wrinkles on the recording material as described above when the recording material is wound while being exerted with the tensile force by the winding device. These wrinkles are generated on a recording surface of the recording material, and cause degradation of the recording quality such as uneven recording, kinking, and blurring when exercising recording by the recording head. Therefore, in the configuration in which the recording material is wound by the winding device, the recording quality cannot be satisfied for both the tarpaulin and the vinyl chloride-based film even when the heat control is performed according to the recording material.

### SUMMARY OF THE INVENTION

In view of problems as described above, the present invention provides a recording apparatus which allows smooth conveyance of various recording materials even the recording materials have different characteristics so that high precision and high quality of images are realized.

The present invention provides a recording apparatus including: a conveying unit configured to convey a recording material; a recording unit configured to eject liquid on to the recording material conveyed by the conveying unit so as to perform recording in an area of a recording operation; a platen provided so as to face the recording unit in the area of the recording operation and configured to support the recording material; a winding device configured to wind the recording material having been subjected to the recording by the recording unit and having passed through the area of the recording operation; and a conveyance resisting unit arranged between the platen and the winding device and configured to come into contact with a surface of the recording material to exert a conveyance resistance with respect to the direction of conveyance of the recording material. The recording apparatus also includes a conveyance resistance switching mechanism configured to switch the state between a state of exerting a predetermined conveyance resistance by the conveyance resisting unit and a state of reducing the predetermined conveyance resistance or a state of releasing the exertion of the predetermined conveyance resistance. The conveyance resistance exerted by the conveyance resisting unit is larger than a difference between a conveying force by the winding device and a predetermined conveying force for causing the recording material to be conveyed, and is smaller than a sum of the conveying force of the conveying unit and the conveying force of the winding device.

Preferably, smooth conveyance of the recording material is achieved also for the recording materials of different properties by configuring the conveyance resisting unit so as to be capable of switching the state of exertion of the conveyance resistance. Therefore, the smooth conveyance of the recording material is achieved without impairing the recording quality irrespective of the types of the recording material, heating temperatures, and the winding device.

Further features of the present invention will become apparent from the following description of exemplary embodiments with reference to the attached drawings.

### BRIEF DESCRIPTION OF THE DRAWINGS

FIG. 1 is a cross-sectional view of a printer according to a first embodiment viewed from a side surface.

FIG. 2 is a cross-sectional view of a principal portion of the printer according to the first embodiment shown in FIG. 1 viewed from the side surface.

FIG. 3 is a cross-sectional view of the principal portion of the printer according to the first embodiment shown in FIG. 1 viewed from the side surface.

FIG. 4 is a cross-sectional view of a printer according to a second embodiment viewed from a side surface.

FIG. 5 is a cross-sectional view of a principal portion of the printer according to the second embodiment shown in FIG. 4 viewed from the side surface.

FIG. 6 is a cross-sectional view of the principal portion of the printer according to the second embodiment shown in FIG. 4 viewed from the side surface.

FIG. 7 is a flowchart showing an operation according to the second embodiment.

FIG. 8 is a block diagram showing the second embodiment.

FIG. 9 is a cross-sectional view of the printer according to the second embodiment viewed from the side surface.

FIG. 10 is a flowchart showing the operation according to the second embodiment.

FIG. 11 is a cross-sectional view of a principal portion of a printer according to a third embodiment viewed from a side surface.

FIG. 12 is a perspective view of the principal portion of the printer according to the third embodiment.

FIG. 13 is an enlarged perspective view of a principal portion of a printer according to a fourth embodiment.

FIG. 14 is an enlarged perspective view of the principal portion of the printer according to the fourth embodiment.

FIG. 15 is an enlarged perspective view of the principal portion of the printer according to the fourth embodiment.

### DESCRIPTION OF THE EMBODIMENTS

Referring now to the drawings, embodiments of the invention will be described. Components described in the exemplified embodiments are examples only, and are not intended to limit the scope of the invention. The same or corresponding components are designated by the same numbers throughout the drawings.

### First Embodiment

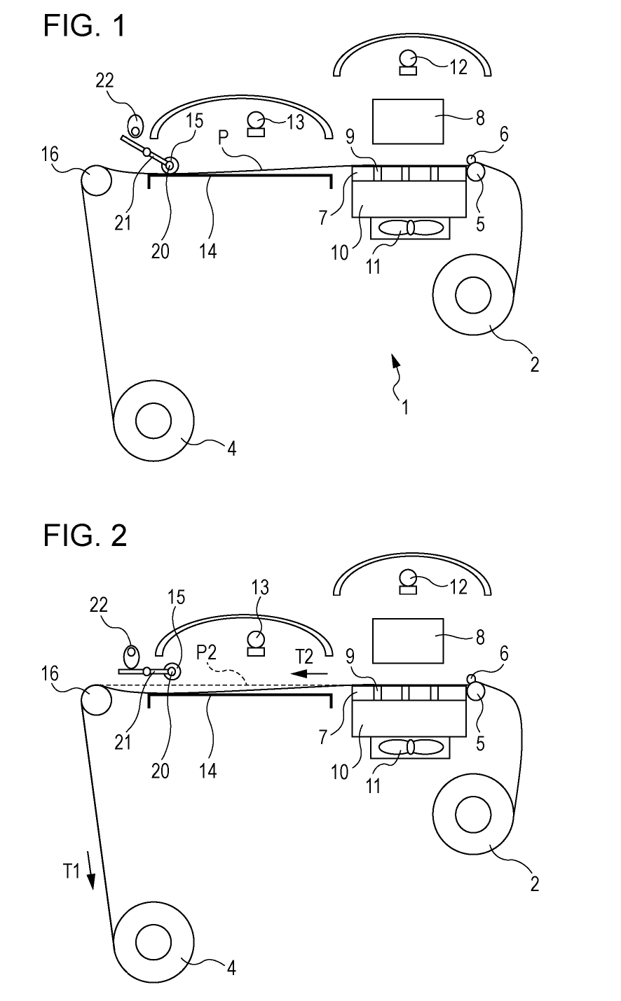

FIG. 1 is a cross-sectional view showing a principal portion of an inkjet recording apparatus in the first embodiment. As shown in FIG. 1, in an inkjet recording apparatus 1 (hereinafter, referred to as “printer 1”) according to the first embodiment, a roll paper 2 is set as a recording material. The printer 1 includes an operating unit (not shown) configured to operate the printer 1, and receives inputs of instructions such as a lateral width of the roll paper 2, online/offline, commands via various switches provided on the operating unit. The printer 1 is provided with a winding device 4 configured to wind a recording material P on the front side of a bottom portion thereof. The recording material P is conveyed into the interior of the printer 1, is nipped between a conveying roller 5 as a conveying unit and a pinch roller 6, is conveyed by the conveying roller 5, and reaches a supporting surface of a platen 7. Arranged at a position facing the supporting surface of the platen 7 is a recording head 8 as a recording unit configured to eject ink as liquid.

The platen 7 is formed with a plurality of suction holes 9 for causing the recording material P to be adhered to the platen 7 to prevent the recording material P from being lifted. Arranged below the platen 7 is a duct 10 which is in communication with the platen 7, and arranged below the duct 10 is a suction fan 11 configured to generate a negative pressure. The negative pressure generated by the suction fan 11 acts on the recording material P via the duct 10 and the suction holes 9, and the recording material P is adhered to the platen 7.

In an area of recording operation of the recording head 8, the recording head 8 ejects ink on the basis of image information, and an image is recorded on the recording material P placed on the platen 7. After the image has recorded one line, the recording material P is conveyed by the conveying roller 5, and the next line is recorded by the recording head 8. During the conveyance of the recording material P, the recording is not performed by the recording head 8. As described above, the recording operation is performed while repeating an intermittent conveying operation which records one line on the recording material P and conveys the recording material P. In contrast, the winding device 4 is driven all the time during the recording operation and winds the recording material P.

Arranged at the position facing the supporting surface of the platen 7 is a first heater 12 as a first heating unit configured to heat the recording material P supported on the supporting surface of the platen 7. In other words, the first heater 12 is arranged at a position facing the recording material P supported by the platen 7. The recording material P supported by the platen 7 is heated by the first heater 12, and ink droplets dropped on a surface (recording surface) of the recording material P are fixed in an early stage. The first heater 12 dries the recording material P. The recording material P on which an image or the like is recorded is discharged from the platen 7 by the conveying roller 5.

Provided on the downstream side of the platen 7 in the direction of conveyance is a paper discharge guide 14 configured to guide a portion of the recording material P passed through the area of the recording operation after the recording. Arranged at a position facing the paper discharge guide 14 is a second heater 13 as a second heating unit configured to heat the surface of the recording material P. The ink droplets on the surface of the recording material P can be dried in an early stage by the second heater 13. Then, the recording material P is wound by the winding device 4 via a turn roller 16.

The recording material P guided by the paper discharge guide 14 is nipped between the paper discharge guide 14 and a weight roller 15 as a conveyance resisting unit. The weight roller 15 is brought into press contact with the recording material P by the weight of the weight roller 15, that is, under its own weight, and a force of friction generated between the recording material P and the weight roller 15 and a force of friction generated between the recording material P and the paper discharge guide 14 corresponds to a conveyance resistance which acts on the recording material. Therefore, the conveyance resistance can be adjusted by adjusting the weight of the weight roller 15.

Since the weight roller 15 is in contact with the recording surface of the recording material P, the recording surface may get soiled by ink which is transferred from the recording material P and then transferred again to the recording material P. In this embodiment, as a countermeasure, a peripheral surface of the weight roller 15, which is a contact portion with respect to the recording material P, is arranged below the second heater 13 in the vicinity thereof, so that the peripheral surface is heated by the second heater 13. By the arrangement of the weight roller 15 below the second heater 13 in the vicinity thereof, ink transferred from the recording material P to the weight roller 15 is fixed by being heated by the second heater 13 to prevent the ink from being transferred again from the weight roller 15 to the recording material P. Accordingly, the recording material P can be prevented from getting soiled. Then, heatproof property of the weight roller 15 is secured by being formed of a metallic material. In this embodiment, the weight roller 15 is described as being a cylindrical roller. However, the invention is not limited thereto, and may be other shapes such as a square shape or a flat plate shape as long as it is a shape which provides the recording material P with the conveyance resistance.

The printer 1 is provided with a conveyance resistance switching mechanism which weakens a pressing force of the weight roller 15 with respect to the recording material P or moves the weight roller 15 away from the recording material P. The conveyance resistance switching mechanism adjusts the pressing force that the weight roller 15 exerts the recording material P by causing a force in the direction of weakening the pressing force to act on the weight roller 15, or moving the weight roller 15 away from the recording material P. Consequently, the conveyance resistance switching mechanism acts to reduce the conveyance resistance exerted by the weight roller 15 or to release the conveyance resistance. In other words, the weight roller 15 and the recording material P may be kept in contact with each other, or only weakening the pressing force of the weight roller 15 is also acceptable.

A configuration of the conveyance resistance switching mechanism will be described. The weight roller 15 is rotatably supported at both end portions in the axial direction by a bearing 20, and the bearing 20 is attached to one end portion of a release lever 21. The center portion of the release lever 21 is rotatably supported by a supporting portion (not shown) in the printer 1. Provided rotatably in the vicinity of the other end portion of the release lever 21 is a release cam 22.

By causing the release cam 22 to rotate by a drive source (not shown), a cam surface of the release cam 22 comes into contact with and presses the other end portion of the release lever 21. By the cam surface of the release cam 22 pressing the other end portion of the release lever 21, the pressing force exerted on the recording material P by the weight roller 15 is reduced. When the release cam 22 is further rotated, the release lever 21 rotates about a rotation bearing 21a, and the weight roller 15 supported by one end portion of the release lever 21 is lifted upward. Accordingly, a pressed contact state of the weight roller 15 with respect to the recording material P is released, and the conveyance resistance generated by the weight roller 15 becomes “zero”.

In contrast, when exerting the conveyance resistance on the recording material P, the release cam 22 is rotated by the drive source to rotate the release lever 21 by the weight of the weight roller 15, so that the weight roller 15 is pressed into contact with the recording material P in the same operation as described above. Then, by rotating the release cam 22 to further rotate the release lever 21, the pressing force exerted by the weight roller 15 is adjusted to control the release cam 22 to stop rotation at a position where the predetermined conveyance resistance is exerted.

FIG. 2 is a cross-sectional view showing a principal portion of the printer 1 from a side surface. The state of a recording material P2 indicated by a broken line in FIG. 2 shows a state in which the recording material P2 is conveyed by the conveying roller 5 and the winding device 4 while being exerted with a tensile force. In this case, the weight roller 15 is released from a state of exerting the conveyance resistance by the operation described above, and is in a state not exerting the conveyance resistance on the recording material P.

In this state, a tensile force T1 is exerted on the recording material P2 by a conveying force by the winding device 4, and a tensile force T2 is also generated on the recording material P positioned on the supporting surface of the platen 7. Therefore, since a force acts in the direction to peel the recording material P off the supporting surface of the platen 7, the recording material P2 is prevented from being adhered to the platen 7. In other words, according to the first embodiment, even when the recording material having an adhesiveness to stick on the supporting surface of the platen 7 by being heated and hence being difficult to be conveyed solely by the conveying roller 5 such as a tarpaulin is used, smooth conveyance is achieved.

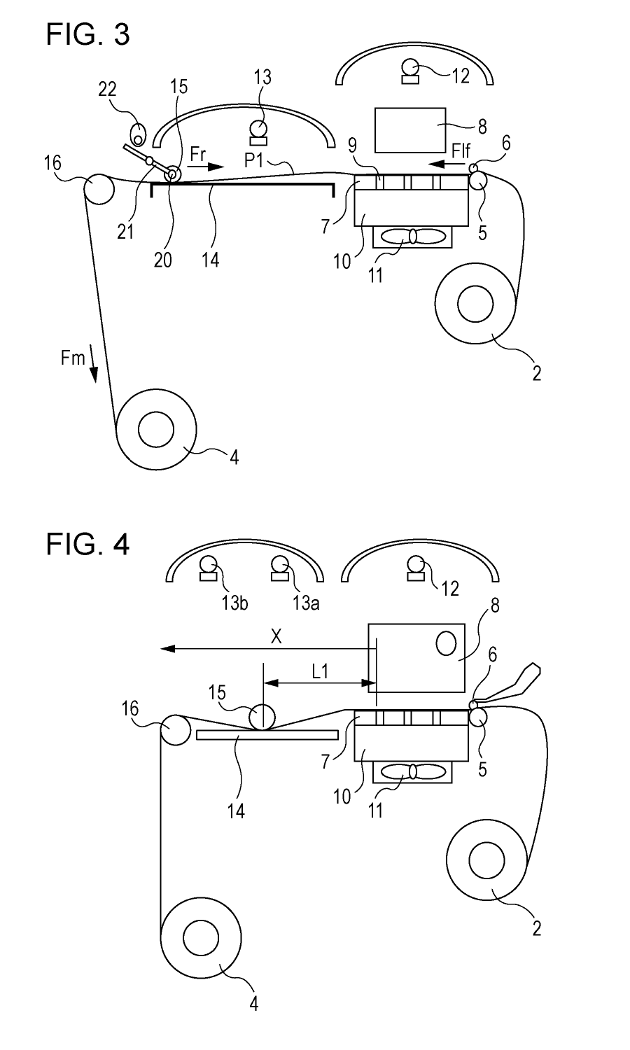

Subsequently, a state in which the conveyance resistance is exerted on the recording material P by the weight roller 15 as shown in FIG. 3 will be described. A state of a recording material P1 exerted with the conveyance resistance by the weight roller 15 is shown by a solid line in FIG. 3. An operation of exerting the conveyance resistance is the same as described above. Here, the conveyance resistance exerted by the weight roller 15 is expressed by Fr, the conveying force (winding force) of the winding device 4 is expressed by Fm, and the conveying force of the conveying roller 5 is expressed by Flf. The conveying force required for conveying the recording material P against the conveyance resistance exerted by a guide, a platen, and a supporting portion of a roll to the recording material P is expressed by Fα. In other words, the reference sign Fα is a conveying force required for conveying the recording material P in a state in which the conveyance resistance Fr exerted by the weight roller 15 does not act on the recording material P.

The conveyance resistance Fr by the weight roller 15 is larger than the difference between the conveying force Fm of the winding device 4 and a predetermined conveying force Fα required for conveying the recording material. In other words, the recording material P being exerted with the conveyance resistance Fr by the weight roller 15 cannot be conveyed only with the conveying force Fm of the winding device 4. In other words, the conveying force Fm of the winding device 4 is smaller than the conveying force required for conveying the recording material on which the conveyance resistance Fr from the weight roller acts. The conveyance resistance Fr is set to be smaller than the sum of the conveying force Flf by the weight roller 15 and the conveying force Fm of the winding device 4.

In other words, the relationship is expressed as follows.

Fm+Flf>Fr>Fm−Fα Expression 1

In order to set the conveying forces to have the relationship as described, the respective conveying forces Fr, Fm, Flf, and Fα may be set to be the predetermined values. Here, the predetermined conveying force Fα means to have a maximum tensile force which can be exerted to a portion of the recording material P between the platen 7 and the weight roller 15, and is a value changed according to the recording material P. When the predetermined conveying force Fα is to large, wrinkles are generated on the recording material P between the platen 7 and the weight roller 15. The value of the predetermined conveying force Fα employed here is a value derived by the inventors on the basis of an experiment.

Subsequently, setting of the respective conveying forces Fr, Fm, Flf will be described.

First of all, the conveyance resistance Fr exerted by the weight roller 15 will be described. The weight roller 15 generates the conveyance resistance Fr of the recording material P by coming into press-contact with the recording material P1 by the action under its own weight. Therefore, the magnitude of the conveyance resistance Fr varies in proportion to the magnitude of the weight of the weight roller 15. In other words, the conveyance resistance Fr can be adjusted so as to increase the pressing force by forming the weight roller 15 of a material having a relatively large specific gravity such as stainless or iron, or by increasing the weight by increasing the volume for example.

Subsequently, the conveying force Fm of the winding device 4 will be described. The winding device 4 is provided with a torque limiter (not shown), and is configured not to generate a winding force (conveying force) exceeding a torque value limited by the torque limiter. Therefore, by adjusting the resistance force by the torque limiter, the conveying force Fm of the winding device 4 can be adjusted.

Subsequently, the conveying force Flf by the conveying roller 5 will be described. As described above, the conveying roller 5 generates the conveying force Flf by rotating the conveying roller 5 in a state in which the recording material P1 is nipped and gripped between the conveying roller 5 and the pinch roller 6. Therefore, the conveying force Flf can be adjusted by adjusting a nipping force (gripping force) exerted by the conveying roller 5 and the pinch roller 6. In other words, adjustment of the conveying force Flf of the conveying roller 5 is achieved only by adjusting the nipping force.

In this manner, since the respective conveying forces Fr, Fm, Flf, Fα can be adjusted independently in this configuration, and hence can be adjusted to satisfy the relationship shown in the Expression 1. In the winding device 4, the conveying force Fm varies with the winding diameter of the roll on which the recording material P is wound. In other words, the conveying force Fm may be adjusted in advance so that the Expression 1 is satisfied with a maximum value (Fm_max) and a minimum value (Fm_min).

In other word, both of the conveying force Fm_min and the conveying force Fm_max may only need to be considered.

For example, the Expression 1 is satisfied by setting the following values;

Fm_max=19.6N, Fm_min=9.8N, Flf=39.2N, Fr=29.4N, Fα=4.9N.

Subsequently, the intermittent action of the recording material P when being conveyed will be described.

As described above, the conveying roller 5 may take states in which the conveying force Flf of the conveying roller 5 is present and absent during the recording action in order to perform the intermittent feed of the recording material P. The case where the conveying force Flf of the conveying roller 5 is not present and the conveying force Flf is present will be described separately with reference to FIG. 3.

First of all, the state in which the conveying force Flf of the conveying roller 5 is not present, that is, the state in which the conveying roller 5 is not operating will be described.

Since the winding device 4 is continuously operated, the conveying force Fm always acts on the recording material P. This state is expressed by the right-hand side Fr>Fm−Fα of the Expression 1 and is set so that the conveyance resistance Fr exerted by the weight roller 15 becomes larger than the difference between the conveying force Fm of the winding device 4 and the predetermined conveying force Fα. Therefore, on the upstream side of the weight roller 15, the tensile force is not exerted on the recording material P or only a tensile force as small as it does not cause generation of wrinkles is exerted. Consequently, the expansion in the direction of conveyance and the contraction in the direction of the width generated on the recording material P are reduced between the platen 7 and the weight roller 15, so that a portion of the recording material P1 between the conveying roller 5 and the weight roller 15, more specifically, a portion supported by the platen 7 is prevented from being subject to the generation of wrinkles.

Although the tensile force in the direction of conveyance generated on the recording material is weakened on the upstream side of the weight roller 15, the tensile force is exerted on a portion of the recording material P between the weight roller 15 and the winding device 4. Therefore, when the conveying force Flf of the conveying roller 5 acts on the recording material P, the recording material P is conveyed in good response, so that the correct winding is achieved. In this manner, both of the restraint of generation of wrinkles and the conveyance in good response are enabled by exerting the conveying force of the winding device 4 and the conveyance resistance of the weight roller 15 on the recording material.

Subsequently, the state in which the conveying force Flf of the conveying roller 5 is present, that is, the state in which the conveying roller 5 is operating will be described. When the conveyance by the conveying roller 5 is started, that is, when the conveying force Flf is exerted on the recording material P, the recording material P is conveyed on the platen 7. The portion of the recording material P between the platen 7 and the weight roller 15 is slightly sagged for a moment by the conveyance resistance Fr exerted by the weight roller 15. However, the conveying force Flf is transmitted to a portion right below the weight roller 15 immediately via the recording material P. Therefore, the conveying force at the portion right below the weight roller 15 is expressed by Fm+Flf.

In this case, since the left hand side Fm+Flf>Fr of the Expression 1 is satisfied, the conveying force Fm+Flf is larger than the conveyance resistance Fr. Therefore, the recording material P1 is conveyed along the direction of conveyance. At this time, the conveying force Flf of the conveying roller 5 acts on the recording material P as a compressing force, the tensile fore is not exerted on the portion of the recording material P between the platen 7 and the weight roller 15. Since the tensile force is exerted on the portion of the recording material P between the weight roller 15 and the winding device 4, correct winding is achieved by the winding device 4.

In this operation, for example, even when the recording material is a material which is softened by being heated and is subject to generation of wrinkles when a tensile force is exerted in the softened state such as vinyl chloride film, the tensile force generated on the recording material P itself between the platen 7 and the weight roller 15 is released during the recording operation. Therefore, the generation of the wrinkles in the area of the recording operation is restrained. Therefore, occurrence of uneven recording, kinking, and blurring is restrained, and hence the recording quality is improved.

In this manner, with such the configuration that the weight roller 15 which exerts the conveyance resistance Fr is provided and the conveyance resistance Fr can be switched between the state of being exerted and the state of being released, the smooth conveyance of the heated recording material is achieved even when the recording materials of different properties are used.

When releasing the conveyance resistance Fr by the weight roller 15, it can be performed in the state in which the weight roller 15 is still in contact with the recording material P. In this case, the conveyance resistance Fr may need only be reduced by weakening the pressing force of the weight roller 15 with respect to the recording material P and adjusted to conveyance resistances Fr which does not satisfy the Expression 1.

As described above, according to the embodiment, the smooth conveyance of the recording material is achieved also for the recording materials of different properties by configuring the weight roller 15 so as to be capable of switching the state of exertion of the conveyance resistance.

For example, the recording material having adhesiveness with respect to the platen 7 when being heated to high temperatures such as the tarpaulin can easily be separated from the platen 7 by exerting a tensile force on the recording material by releasing the conveyance resistance by the weight roller 15.

In contrast, as regards the recording material such as vinyl chloride film, since the tensile force is not generated on the recording material P in the area of the recording operation while the recording head 8 is in the recording operation by exerting the conveyance resistance Fr exerted by the weight roller 15, the generation of the wrinkles on the recording material P itself is restrained.

Therefore, the recording material P can be conveyed without impairing the recording quality. In other words, even with the recording material heated to high temperatures, the influence of the tensile force generated by the winding device, which causes the generation of wrinkles, can be avoided.

Therefore, according to the embodiment, the smooth conveyance of the recording material is achieved without impairing the recording quality irrespective of the types of the recording material, heating temperatures, and the winding device.

### Second Embodiment

Subsequently, a second embodiment will be described specifically on a configuration and control of restraint of a trace of the weigh controller.

FIG. 4 is a drawing showing a positional relationship between a recorded image area and the weight roller 15 immediately after the recording is ended. As shown in FIG. 4, the weight roller 15 is in contact with an image area X immediately after a recording operation is ended.

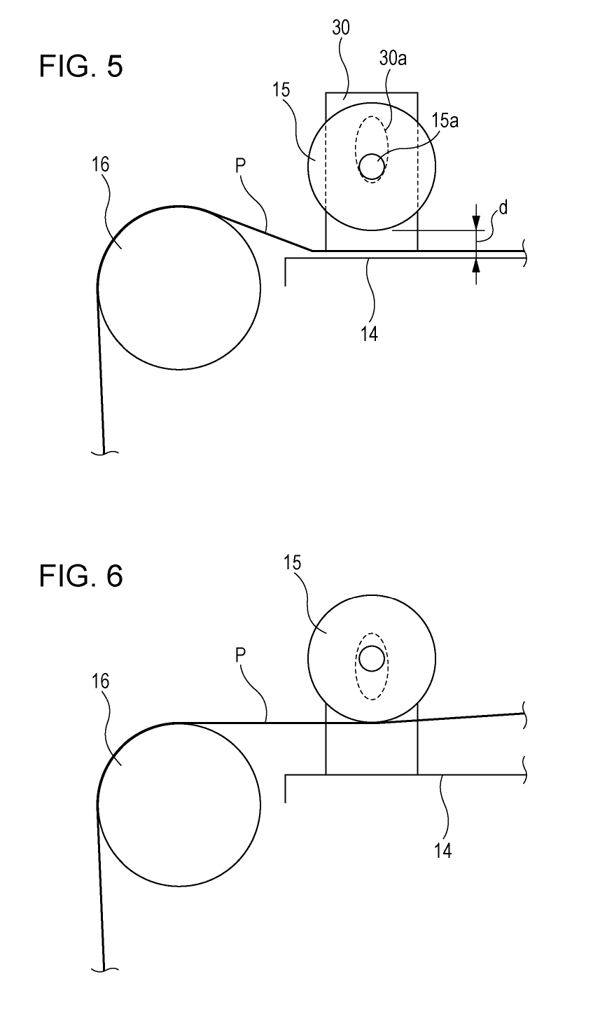

FIG. 5 is an enlarged cross-sectional view of a portion in the periphery of the weight roller 15 showing a state in which the recording material P is sagged (in the state in which no tension is exerted).

FIG. 6 is an enlarged cross-sectional view of the portion in the periphery of the weight roller 15 showing a state in which a tension is exerted on the recording material P.

The weight roller 15 includes shaft portions 15a at both ends thereof, and bearings 30 configured to rotatably support the shaft portions 15a are provided on a main body. The bearings 30 are elongated holes 30a elongated in the vertical direction. In other words, the weight roller 15 is movable in the vertical direction with respect to the bearings 30. The weight roller 15 is configured to have a slight gap d with respect to the paper discharge guide 14 even when being supported at lowest portions of the elongated holes 30a.

When the recording material P is sagged in this configuration, the recording material P extends along the paper discharge guide 14, and the weight roller 15 and the recording material P do not come into contact with each other (FIG. 5).

When a tension is exerted on the recording material P or the recording material P is lifted due to the wrinkles, the recording material P comes into contact with the weight roller 15 and lifts the weight roller 15. When the weight roller 15 and the recording material P come into contact with each other, the conveyance resistance is exerted on the recording material P by the weight roller 15.

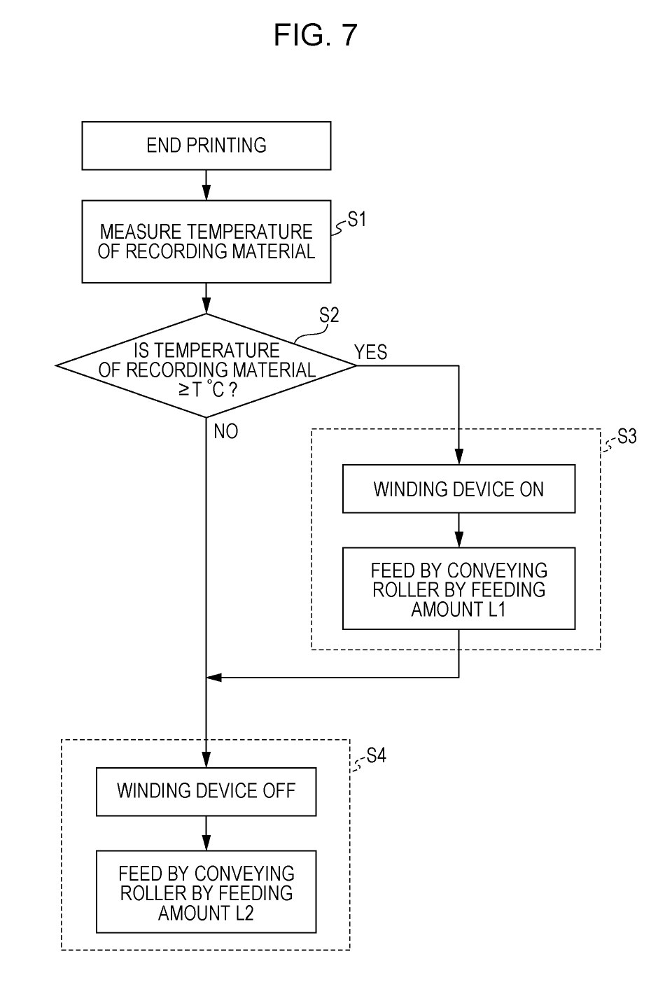

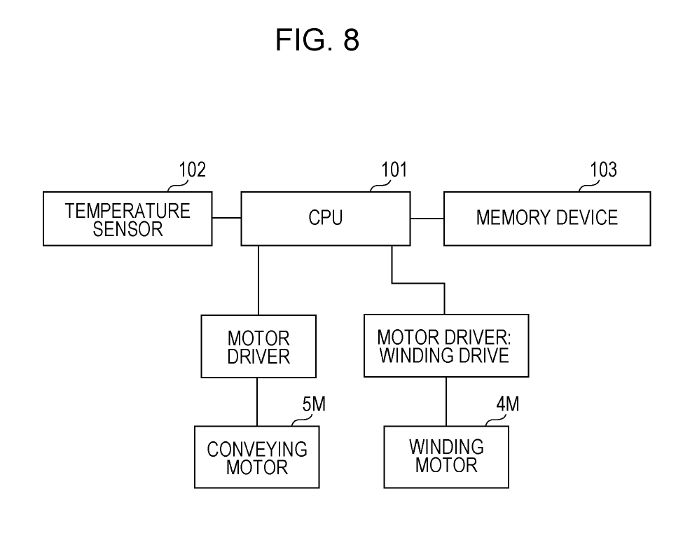

In a state immediately after the recording is ended shown in FIG. 4, the tension is exerted on the recording material P as shown in FIG. 6. Therefore, if the recording material P is left untouched, the image area of the recording material P is subjected to a trace of the weight roller 15. A sequence (flowchart) for restraining the formation of the trace and a block diagram are shown in FIG. 7 and FIG. 8, respectively.

In FIG. 8, reference numeral 101 designates a CPU, and reference numeral 103 designates a memory device (memory unit). Reference numeral 102 designates a temperature sensor, reference sign 4M designates a winding motor configured to drive the winding device 4, reference sign 5M designates a conveying motor configured to drive the conveying roller 5.

The higher the surface temperature of the recording material P and the higher the contact pressure becomes, the more trace is formed by the weight roller.

In FIG. 7 and FIG. 8, when the recording operation is ended, the CPU 101 of the main body controls to measure the surface temperature of the recording material P by the temperature sensor 102 (Step S1). The temperature sensor 102 is a non-contact temperature sensor including temperature sensors for controlling heaters 12, 13a, 13b.

Upon receipt of an output from the temperature sensor 102, the CPU 101 determines whether the surface temperature is equal to or higher than a predetermined temperature T° C. (Step S2). If it is not higher than T° C., the winding device 4 is stopped and the conveying roller 5 is driven to convey the recording material P by a feeding amount L2 (Step S4). If the recording material P is conveyed by the feeding amount L2 by the conveying roller 5 in a state in which the winding device 4 is stopped, the recording material P starts to sag by losing the tension from the upstream side of the weight roller 15. Since the downstream side of the weight roller 15 does not move due to the action of the conveyance resistance of the weight roller 15, the recording material P does not sag at the beginning. However, when the recording material P moves away from the weight roller 15, the recording material P starts sagging. The feeding amount L2 is set to an amount until the recording material P moves away from the weight roller 15 in advance. In other words, the recording material P is set to the feeding amount L2 which does not move the downstream side of the weight roller 15 but moves on the upstream side to cause sagging. The feeding amount L2 at this time is stored in the memory unit (feeding amount memory unit) 103.

In this manner, by feeding the recording material P by the feeding amount L2 by stopping the winding device and driving the conveying roller 5, the tension is cancelled and the contact between the weight roller 15 and the recording material P can be released.

Subsequently, the action to be taken when the output from the temperature sensor is equal to or higher than T° C. will be described.

If the output of the temperature sensor is equal to or higher than T° C., the trace of the weight roller 15 is left significantly easily. In order to protect the image area, the recording material P is fed until the portion of the recording material P right below the weight roller 15 is moved out from a recording area, and then a contact releasing operation between the weight roller 15 and the recording material P described above (Step S4) is performed. The operation will be described below.

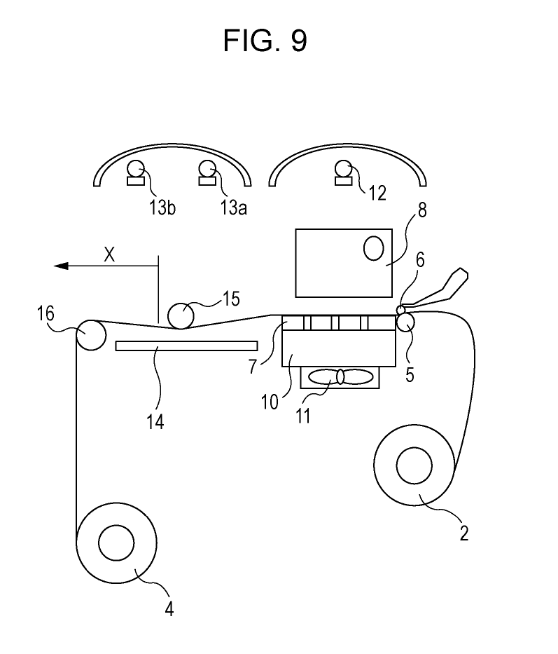

The CPU firstly drives the winding device 4 by a driver for driving the wiring driver and, simultaneously, drives the conveying roller 5 by a driver for driving the conveying roller to convey the recording material P by a feeding amount L1 (Step S3). When the recording material P is conveyed by feeding amount L1, as shown in FIG. 9, the portion of the recording material P in contact with the weight roller 15 is not the image area X, but is a blank space. The feeding amount L1 is determined by the distance from a recording head to the weight roller 15, and is set to this distance in advance.

Immediately after the recording material P is conveyed by the feeding amount L1, the recording material P is in contact with the weight roller 15 as immediately after the recording shown in FIG. 4 and FIG. 6. From this state, the procedure goes to Step S4 in which the conveying roller 5 conveys the recording material P by the feeding amount L2. The tension of the recording material P is cancelled, and the weight roller 15 moves away from the recording material P. Then, the feeding amount L1+L2 at this time is stored in the memory device 103.

In this manner, the recording material P is conveyed until the weight roller 15 does not come into contact with the image area first, and then the recording material P is moved away from the weight roller 15. Therefore, the image is reliably protected.

Although the temperature T described above may vary depending on the recording material, temperatures from 50 to 70° C. are applicable according to the experiments conducted by the inventors.

The series of sequence described above is omitted when recording a plurality of pages continuously because a waiting time is short between pages. After the recording of the image of the last page is ended, the sequence from Step S1 onward is started. Accordingly, increase in the time required between the pages can be restrained. Even between the pages of the continuous recording, this sequence is performed in the case where a process of suction recovery is included. In this case, by performing the sequence in parallel to the process of suction recovery, the increase in the time required between pages can be restrained.

Subsequently, an operation to start the recording will be described.

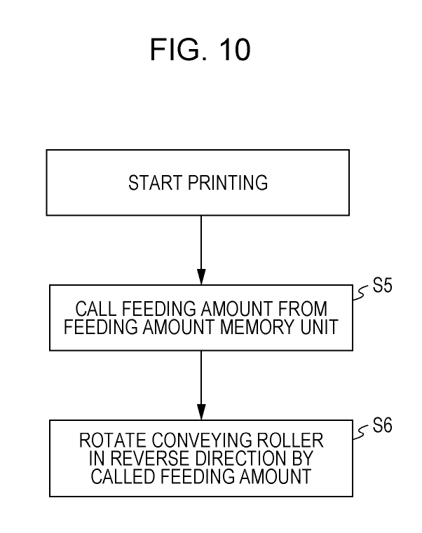

FIG. 10 is a flowchart showing a sequence of starting the recording.

The CPU firstly calls the feeding amount stored in the feeding amount memory unit (Step S5), and rotates the conveying roller 5 in the reverse direction by a called amount, and returns the recording material P. Accordingly, the recording material P moves to a print end position (Step S6). By starting the recording from this state, the recording material P can be used without waste.

The image area comes into contact with the weight roller 15 in this return sequence only when a print end sequence at temperatures of T° C. or higher is performed. Therefore, the contact between the recording area and the weight roller 15 can be minimized.

Accordingly, damages caused by the contact between the image area and the weight roller 15 performed many times can be restrained.

The sequence of starting the recording is performed after a preheat process (warming-up process using heat or the like for warming up the recording material) is ended when the preheat process is performed before starting the recording in order to avoid the contact between the recording material P during the preheating and the weight roller 15.

### Third Embodiment

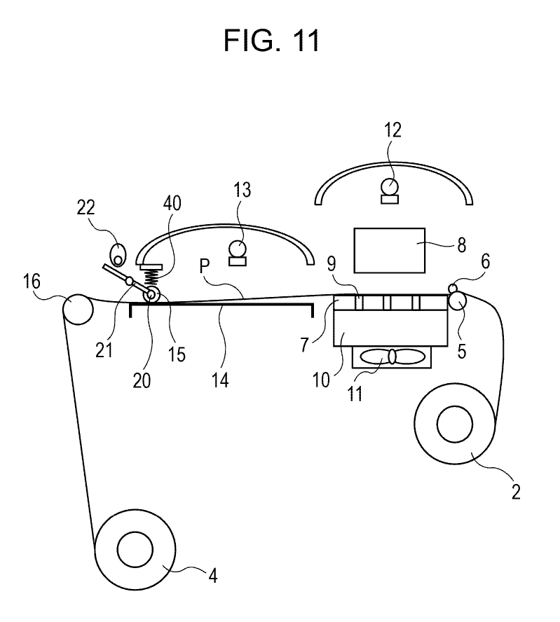

FIG. 11 is a cross-sectional view showing a principal portion of a third embodiment. In the third embodiment, the same components as in the first embodiment are designated by the same reference numerals as in the first embodiment, and repeated description is omitted.

An urging spring 40 as an urging unit for the weight roller 15 is arranged in the vicinity of the weight roller 15, and the weight roller 15 is urged downward in the direction of gravitational force by an urging force of the urging spring 40. The conveyance resistance Fr is generated by the urging force of the urging spring 40 and the weight of the weight roller 15. Accordingly, by setting the weight of the weight roller 15 and the urging force of the urging spring 40, the conveyance resistance Fr can be set freely. As a detailed example of the urging unit, a resilient member such as a spring is generally used. The operation of switching the conveyance resistance between the state of being exerted and the state of being released is preformed in the same manner as the first embodiment.

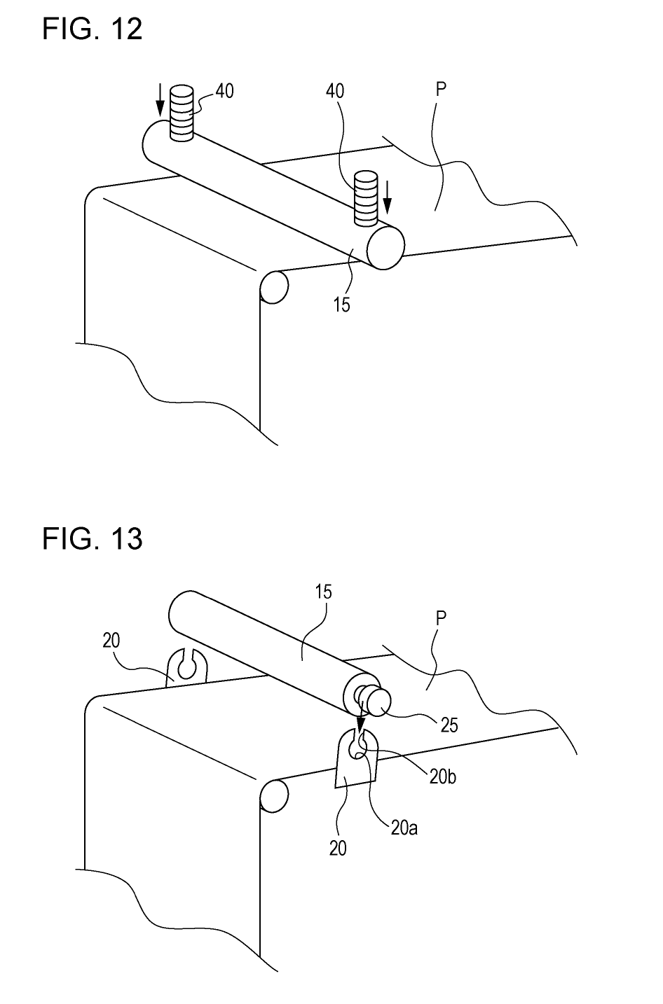

As shown in FIG. 12, the weight roller 15 is arranged so as to come into contact with the recording material P entirely in the direction of width orthogonal to the direction of conveyance of the recording material P. In this configuration, the conveyance resistance can be exerted uniformly in the direction of the width of the recording material P, so that the generation of wrinkles can be restrained further effectively.

### Fourth Embodiment

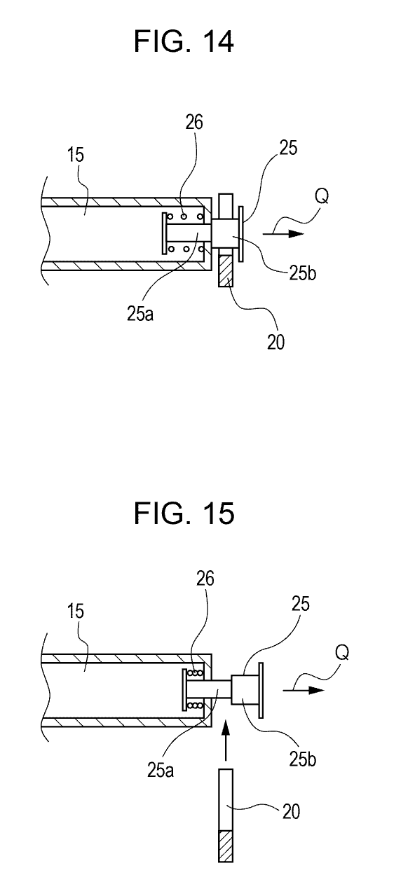

Referring now to FIG. 13 to FIG. 15, the weight roller 15 and the conveyance resistance switching mechanism in a fourth embodiment will be described. FIG. 13 shows a perspective view of the principal portion, and FIG. 14 and FIG. 15 show cross-sections thereof.

In the fourth embodiment, the weight roller 15 is configured to be detachably attached to a conveying path of the recording material, and switching of the conveyance resistance between the state of being exerted and the state of being released is performed by attaching and detaching the weight roller 15. A configuration of allowing detachable attachment of the weight roller 15 will be described.

As shown in FIG. 13, a set of bearings 20 are arranged on both ends of the weight roller 15. The bearings 20 each include a receiving portion 20a configured to rotatably support the weight roller 15 and a slit 20b formed on an upper portion of the receiving portion 20a. The weight roller 15 is inserted at the both ends thereof into the receiving portions 20a from the slits 20b and is rotatably supported by the receiving portions 20a.

As shown in FIG. 13 and FIG. 14, the weight roller 15 is provided at the both ends thereof with a set of tensile shafts 25. The tensile shafts 25 are each a stepped shaft including a small-diameter shaft portion 25a as a small-diameter portion and a large-diameter shaft portion 25b. Normally, the tensile shafts 25 are deviated axially inward of the weight roller 15 as shown in FIG. 14 by an urging force of compression springs 26. The diameter of the small-diameter shaft portion 25a of the tensile shaft 25 is formed to be smaller than the width of the slit 20b of the bearings 20 described above, so that the small-diameter shaft portion 25a is allowed to pass through the slit 20b.

When removing the weight roller 15 configured as described above from the bearing 20, the tensile shaft 25 is pulled axially in the direction indicated by an arrow Q shown in FIG. 14 against the urging force of the compression spring 26 to expose the small-diameter shaft portion 25a from the interior of the weight roller 15. In a state in which the small-diameter shaft portion 25a is exposed from the weight roller 15, the large-diameter shaft portion 25b is removed from the receiving portion 20a by passing the small-diameter shaft portion 25a through the slit 20b. Then, by performing a moving operation of the tensile shaft 25 described above respectively at the both ends of the weight roller 15, the weight roller 15 can be removed from the bearings 20.

When mounting the weight roller 15 on the bearings 20, the large-diameter shaft portion 25b is supported by the receiving portion 20a by pulling the tensile shaft 25 in the axial direction and allowing the small-diameter shaft portion 25a to pass along the slit 20b in the same manner as described above. By stopping a pulling operation of the tensile shaft 25, the tensile shaft 25 is returned axially inward of the weight roller 15 by the urging force of the compression spring 26, so that the large-diameter shaft portion 25b is fitted to the receiving portion 20a. Accordingly, the weight roller 15 is rotatably supported by the bearings 20. At this time, the weight roller 15 is at a position coming into contact with the recording material P, and exerts the conveyance resistance to the recording material P. In this manner, the weight roller 15 is detachably attached to the recording apparatus.

This embodiment is configured to allow a user to perform attaching and detaching the weight roller 15 easily depending on the type of the recording material to be used, so that the switching of the conveyance resistance between the state of being exerted and the state of being released with respect to the recording material can be performed as desired by this attaching and detaching operation.

For example, the weight roller 15 may only need to be removed when vinyl chloride film is used as the recording material, while the weight roller 15 may only need to be attached when tarpaulin is used as the recording material. In this manner, by the attachment and detachment of the weight roller 15 by the user according to the requirement, the conveyance resistance may be switched between the state of being exerted and the state of being released.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-193570 filed Aug. 31, 2010, which is hereby incorporated by reference herein in its entirety.

What is claimed is:

1. A recording apparatus comprising:
a conveying unit configured to convey a recording material;
a recording unit configured to eject liquid on to the recording material conveyed by the conveying unit so as to perform recording in an area of a recording operation;
a platen provided so as to face the recording unit in the area of the recording operation and configured to support the recording material;
a winding device configured to wind the recording material having been subjected to the recording by the recording unit and having passed through the area of the recording operation; and
a conveyance resisting unit arranged between the platen and the winding device and configured to come into contact with a surface of the recording material to exert a conveyance resistance with respect to the direction of conveyance of the recording material, wherein
the conveyance resistance exerted by the conveyance resisting unit is larger than a conveying force exerted by the winding device.

2. The recording apparatus according to claim 1, wherein the conveyance resistance exerted by the conveyance resisting unit is smaller than a sum of the conveying force of the winding device and a conveying force of the conveying unit.

3. The recording apparatus according to claim 2, wherein the conveying force of the winding device is smaller than a conveying force required for conveying the recording material on which the conveyance resistance is exerted by the conveyance resisting unit.

4. The recording apparatus according to claim 1, wherein the conveyance resistance exerted by the conveyance resisting unit can be adjusted by changing a weight of the conveyance resisting unit.

5. The recording apparatus according to claim 1, comprising an urging unit configured to urge the conveyance resisting unit toward the recording material and the conveyance resistance exerted by the conveyance resisting unit is adjustable by changing the urging force by the urging unit.

6. The recording apparatus according to claim 5, wherein the urging unit is a resilient member and is provided so that the urging force acts downward in the direction of gravitational force.

7. The recording apparatus according to claim 1, wherein the conveyance resisting unit exerts the conveyance resistance on the recording material entirely in the direction of the width orthogonal to the direction of conveyance.

8. The recording apparatus according to claim 1, comprising:
a first heating unit arranged at a position facing the recording material supported by the platen and configured to heat the recording material; and
a second heating unit arranged on the downstream side of the recording material in the direction of conveyance with respect to the area of the recording operation, and configured to heat the recording material.

9. The recording apparatus according to claim 8, wherein the conveyance resisting unit comes into contact with the recording material at a position downstream of the recording material in the direction of conveyance with respect to the second heating unit.

10. The recording apparatus according to claim 9, wherein a portion of the conveyance resisting unit coming into contact with the recording material is formed of a metallic material.

11. The recording apparatus according to claim 1, wherein the conveyance resisting unit is detachably attached to the recording apparatus.

12. The recording apparatus according to claim 9, wherein the conveyance resisting unit includes a shaft portion provided with a small-diameter portion and the recording apparatus includes a bearing configured to support the shaft and formed with a slit, wherein the conveyance resisting unit is detachably attached to the bearing by allowing the small diameter portion to pass through the slit.

13. The recording apparatus according to claim 1, wherein the conveyance resisting unit is a cylindrical roller.

14. A recording apparatus comprising:
a conveying unit configured to convey a recording material;
a recording unit configured to perform recording on the conveyed recording material;
a platen provided so as to face the recording unit and configured to support the recording material;
a winding device configured to wind a portion of the recording material discharged from the platen;
a heating unit configured to dry the recording material;
a conveyance resisting unit configured to come into contact with a surface of the recording material between the platen and the winding device and exert a conveyance resistance against the movement in the direction of conveyance of the recording material;
a unit configured to measure the temperature of the recording material;
a memory unit configured to store a feeding amount; and
wherein the recording apparatus is controlled to measure the temperature of the recording material after the recording is ended, feed the recording material by a feeding amount according to the measured temperature, store the feeding amount by the memory unit, and return the recording material by the feeding amount stored in the memory unit when starting the next recording.

15. The recording apparatus according to claim 14, wherein the conveying unit is driven in a state in which the winding device is stopped to weaken a tension of the recording material on the upstream of the conveyance resisting unit when the measured temperature is lower than a predetermined temperature.

16. The recording apparatus according to claim 14 wherein when the measured temperature is higher than the predetermined temperature, the recording apparatus controls to convey the recording material to a position where a recorded image area passed through the conveyance resisting unit, store the feeding amount in the memory unit, and return the recording material by the feeding amount stored in the memory unit when starting the next recording.

17. The recording apparatus according to claim 14, wherein the recording apparatus controls to return the recording material by the feeding amount after a preheat to be performed when starting the next recording is ended.

18. The recording apparatus according to claim 14, wherein when images are to be recorded on a plurality of pages, the recording material is fed by a feeding amount according to the measured temperature after the recording of the last page is ended.

19. The recording apparatus according to claim 14, when performing a process of suction recovery, the recording material is fed by the feeding amount according to the measured temperature in parallel to the process of suction recovery.
